(19) United States
(12) Patent Application Publication
(10) Pub. No.: US 2019/0258201 A1
(43) Pub. Date: Aug. 22, 2019

(54) METHOD FOR CONVERTING A TONER CARTRIDGE PRINTER TO A SECURITY TONER PRINTER

(71) Applicant: UI Technologies, Inc., Las vegas, NV (US)

(72) Inventors: Michael Raymond Josiah, North Patchogue, NY (US); Joseph Dovi, Lake Grove, NY (US)

(73) Assignee: UI Technologies, Inc., Las Vegas, NV (US)

(21) Appl. No.: 16/402,718

(22) Filed: May 3, 2019

Related U.S. Application Data
(63) Continuation-in-part of application No. 15/800,482, filed on Nov. 1, 2017, now Pat. No. 10,310,446.
Application No. 15/800,482 is a continuation-in-part of application No. 15/408,186, filed on Jan. 17, 2017, now Pat. No. 9,835,968.
Application No. 15/408,186 is a continuation-in-part of application No. 15/286,875, filed on Oct. 6, 2016, now Pat. No. 9,835,981.
Application No. 15/286,875 is a continuation-in-part of application No. 15/286,943, filed on Oct. 6, 2016, now Pat. No. 9,835,982.
Application No. 15/286,943 is a continuation-in-part of application No. 15/286,998, filed on Oct. 6, 2016, now Pat. No. 9,835,983.
Application No. 15/286,998 is a continuation-in-part of application No. 14/879,548, filed on Oct. 9, 2015, now Pat. No. 9,488,932.
Application No. 14/879,548 is a continuation-in-part of application No. 14/731,785, filed on Jun. 5, 2015, now Pat. No. 9,383,684.
Application No. 14/731,785 is a continuation-in-part of application No. 15/722,562, filed on Oct. 2, 2017, now Pat. No. 10,324,395.
Application No. 15/722,562 is a continuation-in-part of application No. 15/994,750, filed on May 31, 2018.
Application No. 15/994,750 is a continuation-in-part of application No. 15/722,503, filed on Oct. 2, 2017, now Pat. No. 10,228,637.
(60) Provisional application No. 62/470,639, filed on Mar. 13, 2017.

(51) Int. Cl. G03G 21/16; G03G 15/01; G03G 15/08; G03G 15/00

(52) U.S. Cl. CPC G03G 21/1676; G03G 15/0121; G03G 15/0178; G03G 2215/00987; G03G 15/0867; G03G 15/0894; G03G 15/6585; G03G 15/0863

(57) ABSTRACT

A method of converting a standard toner printer to a security toner printer, comprising the steps: providing a standard toner printer; removing one or more of the toner printing cartridges from the standard toner printer, such that at least one printing cartridge position is empty and there is at least one removed toner printing cartridge; providing one or more empty replacement toner printing cartridges; filling at least one of the one or more empty replacement toner printing cartridges with a mixture of a toner and a taggant, such that one or more security replacement toner printing cartridges are created; wherein the taggant is configured to be detected by a security reader; and installing the one or more security replacement toner printing cartridges into the at least one empty printing cartridge position.

### CROSS-REFERENCE TO RELATED APPLICATIONS

This Patent Application is a Continuation-in-Part Application of U.S. Non-Provisional patent application Ser. No. 15/800,482, titled Method For Converting A Toner Cartridge Printer To A Sublimation Toner Printer, filed on Nov. 1, 2017, now U.S. Pat. No. ______, the contents of which are expressly incorporated herein by this reference as though set forth in their entirety and to which priority is claimed. U.S. Non-Provisional patent application Ser. No. 15/800,482 takes priority from U.S. Provisional Patent Application No. 62/470,639, filed on Mar. 13, 2017, titled Toner Cartridge Printer Devices, Systems, and Methods, the contents of which are expressly incorporated herein by this reference as though set forth in their entirety and to which priority is claimed. This Patent Application is also a Continuation-in-Part Application of U.S. Non-Provisional patent application Ser. No. 15/722,562, titled Toner Cartridge Printer Devices, Systems, And Methods For Under Printing, filed on Oct. 2, 2017, the contents of which are expressly incorporated herein by this reference as though set forth in their entirety and to which priority is claimed. U.S. Non-Provisional patent application Ser. No. 15/800,482, is a Continuation-in-Part of the following U.S. Non-Provisional patent application Ser. Nos., which means that this U.S. Patent Application is also a Continuation in Part of the following U.S. Non-Provisional patent application Ser. No.: (1) Ser. No. 15/408,186, filed on Jan. 17, 2017, titled, Toner Cartridge Printer Devices, Systems, and Methods For Over Printing and Under Printing, now U.S. Pat. No. 9,835,968; (2) Ser. No. 15/286,998, filed on Oct. 6, 2016, titled, Method and System for Converting a Toner Cartridge Printer to a Double White Toner Printer, now U.S. Pat. No. 9,835,983; (3) Ser. No. 15/286,943, filed on Oct. 6, 2016, titled Method And System For Converting A Toner Cartridge Printer To A White, Clear, Metallic, Fluorescent, Or Light Toner Printer, now U.S. Pat. No. 9,835,982; (4) Ser. No. 15/286,875, filed on Oct. 6, 2016, titled, Method and System for Converting a Toner Cartridge Printer to a Metallic, Clear Fluorescent, or Light Toner Printer, now U.S. Pat. No. 9,835,981; (5) Ser. No. 14/879,548, now U.S. Pat. No. 9,488,932, filed on Oct. 9, 2015, titled, Method and System for Converting a Toner Cartridge Printer to a White, Clear, or Fluorescent Toner Printer; (6) Ser. No. 14/731,785, now U.S. Pat. No. 9,383,684, filed on Jun. 5, 2015, titled, Method and System for Converting a Toner Cartridge Printer to a White Toner Printer; the contents of all of which are expressly incorporated herein by this reference as though set forth in their entirety and to which priority is claimed as Continuation in Part. This Patent Application is also a Continuation-in-Part Application of U.S. Non-Provisional patent application Ser. No. 15/944,750, titled Method And System For Converting A Toner Cartridge Printer, filed on May 31, 2018, the contents of which are expressly incorporated herein by this reference as though set forth in their entirety and to which priority is claimed. U.S. Non-Provisional patent application Ser. No. 15/944,750, is a Continuation-in-Part of U.S. Non-Provisional patent application Ser. No. 15/722,503, filed on Oct. 17, 2017, titled Method And System For Converting A Toner Cartridge Printer To A Metallic Or Light Toner Printer, now U.S. Pat. No. 10,228,637.

### FIELD OF USE

The present disclosure relates generally to security taggant toners, toner cartridge printers that use security taggant toner, and, more specifically, to converting a standard toner cartridge toner printer to a printer that use security taggant toner.

### BACKGROUND

Generally, security printing deals with printing at risk documents, such as identification documents, checks, money, secure documents, stock certificates, postage/stamps, certification labels, authentication labels, and the like. The purpose of security printing is to limit forgery, prevent counterfeiting, and make tampering more evident. Security toner printing is a relatively new technology and typically involves a magnetic toner. Another type of security printing uses an ink that includes a non-magnetic taggant. A taggant is a microscopic chemical marker that can be added to the ink itself, to allow various forms of verification. Taggants may be invisible to the naked eye (or, alternatively, may be purposefully visible) and can, usually, only be detected (verified) by special readers. Taggants cannot be removed and they are difficult to reverse engineer. Taggants are typically embedded in the ink during the production process. If taggant ink is being used to print variable information, it makes the packaging almost impossible to duplicate. Importantly, before the method and system of the present disclosure, use of security toner, magnetic or taggant, was exclusively with a printer that has been specially designed to use the security toner. Additionally, the use of taggants with toner has not been disclosed before the present disclosure. Thus, there is a need for device, system, and method for allowing a standard toner cartridge printer to be converted to use a security toner and a security toner with taggant.

### SUMMARY

To minimize the limitations in the cited references, and to minimize other limitations that will become apparent upon reading and understanding the present specification, the toner cartridge printer devices, systems, and methods disclosed herein disclose a taggant printing toner and using this taggant toner to convert a standard toner cartridge printer to a printer that prints using a security toner.

One embodiment may be a taggant toner for printing in a standard toner printer.

Another embodiment may be a method of converting a standard CMYK color toner printer to a CMYK security color taggant toner printer.

Another embodiment may be a method of converting a monochrome toner printer to a monochrome security taggant toner printer.

Another embodiment may be a method of converting a CMYX color printer, wherein the X may be a non-standard color, including, for example, white, metallic, fluorescent, light colors, clear, and clear fluorescent, to a CMYX security color taggant toner printer.

Another embodiment may be a method of converting a five cartridge CMYKX toner printer, wherein K is black, and X is a non-standard color, to a CMYKX security color taggant toner printer.

Preferably, at least one of the one, four or five total toners is a security toner, but multiple of the four or five total toners may be a security toner.

One embodiment may be a method of converting a standard CMYK color toner printer to a CMYK security color toner printer, comprising the steps: providing a standard CMYK color toner printer that comprises four toner printing cartridges: a cyan toner printing cartridge, a magenta toner printing cartridge, a yellow toner printing cartridge, and a black toner printing cartridge; removing one or more of the four toner printing cartridges from the standard CMYK color toner printer, such that at least one printing cartridge position is empty and there is at least one removed toner printing cartridge; providing one or more empty replacement toner printing cartridges; filling at least one of the one or more empty replacement toner printing cartridges with a mixture of a toner and a taggant, such that one or more security replacement toner printing cartridges are created; wherein the taggant is configured to be detected by a security reader; and installing the one or more security replacement toner printing cartridges into the at least one empty printing cartridge position. The one or more empty replacement toner printing cartridges may be the one or more removed toner printing cartridges that have been emptied and cleaned. The step of providing the one or more of the empty replacement toner printing cartridges may comprise: disassembling and cleaning the one or more removed toner printing cartridges. The one or more empty replacement toner printing cartridges may be new. Although usually only one toner cartridge is a security toner cartridge, two, three, or all four toner printing cartridges may be removed and replaced with security replacement toner printing cartridges. The one or more colors of the one or more security replacement toner printing cartridges may match one or more colors of the at least one removed toner printing cartridge. The taggant in the mixture may be approximately 1% to 20% weight by volume of the mixture, and preferably 5% weight by volume of the mixture.

One embodiment may be a method of converting a standard CMYX color toner printer to a CMYX security color toner printer, comprising the steps: providing a standard CMYX color toner printer that comprises four toner printing cartridges: a cyan toner printing cartridge, a magenta toner printing cartridge, a yellow toner printing cartridge, and a non-standard toner printing cartridge; removing one or more of the four toner printing cartridges from the standard CMYX color toner printer, such that at least one printing cartridge position is empty and there is at least one removed toner printing cartridge; providing one or more empty replacement toner printing cartridges; filling at least one of the one or more empty replacement toner printing cartridges with a mixture of a toner and a taggant, such that one or more security replacement toner printing cartridges are created; wherein the taggant is configured to be detected by a security reader; and installing the one or more security replacement toner printing cartridges into the at least one empty printing cartridge position. The one or more empty replacement toner printing cartridges may be the one or more removed toner printing cartridges that have been emptied and cleaned. The step of providing the one or more of the empty replacement toner printing cartridges may comprise: disassembling and cleaning the one or more removed toner printing cartridges. The one or more empty replacement toner printing cartridges may be new. Although usually only one toner cartridge is a security toner cartridge, two, three, or all four toner printing cartridges may be removed and replaced with security replacement toner printing cartridges. The one or more colors of the one or more security replacement toner printing cartridges may match one or more colors of the at least one removed toner printing cartridge. The taggant in the mixture may be approximately 1% to 20% weight by volume of the mixture, and preferably 5% weight by volume of the mixture. The non-standard color toner may be selected from the group of toners consisting of at least one of: white, metallic, fluorescent, light, clear, clear fluorescent, sublimation, ceramic, and combinations thereof.

Another embodiment may be a method of converting a CMYKX color toner printer to a CMYKX security color toner printer, comprising the steps: providing a standard CMYKX color toner printer that comprises five toner printing cartridges: a cyan toner printing cartridge, a magenta toner printing cartridge, a yellow toner printing cartridge, a black toner printing cartridge, and a non-standard toner printing cartridge; removing one or more of the five toner printing cartridges from the CMYKX color toner printer, such that at least one printing cartridge position is empty and there is at least one removed toner printing cartridge; providing one or more empty replacement toner printing cartridges; filling at least one of the one or more empty replacement toner printing cartridges with a mixture of a toner and a taggant, such that one or more security replacement toner printing cartridges are created; wherein the taggant is configured to be detected by a security reader; and installing the one or more security replacement toner printing cartridges into the at least one empty printing cartridge position. The one or more empty replacement toner printing cartridges may be the one or more removed toner printing cartridges that have been emptied and cleaned. The step of providing one or more of the empty replacement toner printing cartridges may comprise: disassembling and cleaning the one or more removed toner printing cartridges. The one or more empty replacement toner printing cartridges may be new. Although usually only one toner cartridge is a security toner cartridge, two, three, four, or all five toner printing cartridges may be removed and replaced with security replacement toner printing cartridges. The one or more colors of the one or more security replacement toner printing cartridges may match one or more colors of the at least one removed toner printing cartridge. The taggant in the mixture may be approximately 1% to 20% weight by volume of the mixture, and preferably 5% weight by volume of the mixture. The non-standard color toner may be selected from the group of toners consisting of at least one of: white, metallic, fluorescent, light, clear, clear fluorescent, sublimation, ceramic, and combinations thereof.

Another embodiment may be a method of converting a standard toner printing cartridge to a security toner printing cartridge, comprising the steps: providing a toner printing cartridge; emptying the toner printing cartridge; providing a toner and a taggant; wherein a security reader is able to detect the taggant; mixing the toner and the taggant in a container, creating a toner-taggant mixture; and filling the toner printing cartridge with the toner-taggant mixture. The toner printing cartridge may be a new toner printing cartridge and wherein a toner removed from the new toner printing cartridge may be the toner that is mixed with the taggant. The toner printing cartridge may be a used toner printing cartridge and wherein a toner removed from the used toner printing cartridge is preferably not reused. The step of emptying the toner printing cartridge may comprise the steps of: disassembling and cleaning the toner printing cartridge. The taggant in the toner-taggant mixture may be approximately 1% to 20% weight by volume of the toner-taggant mixture and may preferably be approximately 5% weight by volume of the toner-taggant mixture.

Another embodiment may be a method of converting a standard monochrome toner printer to a monochrome security toner printer, comprising the steps: providing a standard monochrome toner printer that comprises a toner printing cartridge; removing the toner printing cartridge from the standard monochrome toner printer, such that a printing cartridge position is empty and there is a removed toner printing cartridge; providing an empty replacement toner printing cartridge; filling the empty replacement toner printing cartridge with a mixture of a toner and a taggant, such that a security replacement toner printing cartridge is created; wherein the taggant is configured to be detected by a security reader; and installing the security replacement toner printing cartridge into the empty printing cartridge position. The empty replacement toner printing cartridge may be the removed toner printing cartridge that has been emptied and cleaned. The step of providing the empty replacement toner printing cartridge may comprise: disassembling and cleaning the removed toner printing cartridge. The taggant in the toner-taggant mixture may be approximately 1% to 20% weight by volume of the toner-taggant mixture and may preferably be approximately 5% weight by volume of the toner-taggant mixture.

It is an object of the present disclosure to overcome the deficiencies of the prior art.

Other features and advantages inherent in the taggant security toner and methods for converting a standard toner cartridge printer into security toner printer claimed and disclosed will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps, which are illustrated. When the same numeral appears in different drawings, it refers to the same or like components or steps.

FIG. 1 is a flow block diagram of one embodiment of a method of converting a standard CMYK color toner printer to a CMYK security color taggant toner printer.

FIG. 2 is a flow block diagram of one embodiment of a method of converting a standard CMYX color toner printer to a CMYX security color taggant toner printer.

FIG. 3 is a flow block diagram of one embodiment of a method of converting a standard CMYKX color toner printer to a CMYKX security color taggant toner printer.

FIG. 4 is a flow block diagram of one embodiment of a method of converting a standard toner printing cartridge to a security taggant toner printing cartridge.

FIG. 5 is a flow block diagram of one embodiment of a method of converting a standard monochrome printer to a monochrome security taggant toner printer.

### DETAILED DESCRIPTION OF THE ILLUSTRATIVE EMBODIMENTS

In the following detailed description, numerous specific details are set forth in order to provide a thorough understanding of various aspects of one or more embodiments. However, these embodiments may be practiced without some or all of these specific details. In other instances, well-known methods, procedures, and/or components have not been described in detail so as not to unnecessarily obscure aspects of embodiments.

While multiple embodiments are disclosed, still other embodiments will become apparent to those skilled in the art from the following detailed description. As will be realized, these embodiments are capable of modifications in various obvious aspects, all without departing from the spirit and scope of protection. Accordingly, figures and the detailed descriptions thereof are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about,” may refer to a deviance of between 0.0001-10% from the indicated number or range of numbers.

The present specification discloses systems and methods for converting a toner cartridge printer to a security toner printer. The methods and systems for converting a toner cartridge printer to a security toner printer preferably require no special or dedicated printer drivers.

In the following description, certain terminology is used to describe certain features of one or more embodiments. For purposes of the specification, unless otherwise specified, the term “printing cartridge(s)” generally refers to a toner cartridge, a laser toner cartridge, a LED toner cartridge, a drum cartridge, and/or a combined toner and drum cartridge.

As used herein, the term “toner” generally refers to a powder, particulate, or dry ink that is used in laser printers, printers, and printing machines to form the printed text and images on the medium being printed. Generally, toner particles are melted by the heat of a fuser and bound to the media.

Regarding a CMYX printer, the letter “X” may refer to a non-standard color, such as white, light, clear, clear fluorescent, metallic, ceramic, and/or sublimation.

One embodiment may be a method of converting a standard CMYK color toner printer to a security color taggant toner printer, comprising the steps:
providing a standard CMYK color toner printer, comprising four toner printing cartridges: a cyan toner printing cartridge, a magenta toner printing cartridge, a yellow toner printing cartridge, and a black toner printing cartridge;
removing one or more of the four toner printing cartridges;
providing one or more security toner replacement toner printing cartridges;
wherein the one or more security toner replacement toner printing cartridges comprise a toner and a taggant;
installing the one or more security toner replacement toner printing cartridges;
printing one or more print jobs, wherein the one or more security toner replacement toner printing cartridges are used in the one or more print jobs;
providing a security reader is able to detect the taggant.

The taggant may be mixed with any of the four toners but is preferably mixed with the yellow and/or white toners. If a white toner is mixed with the taggant, the white toner with taggant may typically replace the black toner cartridge. The taggant may preferably be approximately 1% to 20% by volume in the one or more security toner replacement toner printing cartridges and more preferably may be approximately 5% by volume.

Generally, a taggant is a chemical or physical marker added to materials to allow various forms of testing, verification, and authentication. Taggants can take many different forms but are typically microscopic in size and are able to be detected with a security reader. They can be utilized to differentiate authentic products from counterfeits, provide identifying information for traceability purposes (e.g. lot number, company name). Taggants have previously been combined with inks for ink printing, but before the present disclosure have not been combined with toner.

One embodiment may be a CMYX color security toner printer. The CMYX color security toner printer may comprise: four toner printing cartridges: a cyan toner printing cartridge, a magenta toner printing cartridge, a yellow toner printing cartridge, and a fourth toner printing cartridge. The fourth toner printing cartridge may be black, white, metallic, fluorescent, light, clear, clear fluorescent, or ceramic toner. At least one of the four toner printing cartridges comprises a taggant. The taggant may be approximately 1-20% by volume and mixed with toner at 80-99% by volume. The taggant is preferably 5% by volume. In other embodiments, the printer may be a five cartridge CMYKX printer, wherein K is black and X is a non-standard color.

Another embodiment of the conversion method may comprise the steps:
providing a standard CMYK color toner printer, comprising four toner printing cartridges;
printing cartridges: a cyan toner printing cartridge, a magenta toner printing cartridge, a yellow toner printing cartridge, and a black toner printing cartridge;
printing cartridges: a cyan toner printing cartridge, a magenta toner printing cartridge, a yellow toner printing cartridge, and a black toner printing cartridge;
removing one or more of the four toner printing cartridges, such that at least one printing cartridge position is empty and there is at least one removed toner printing cartridge;
providing one or more empty replacement toner printing cartridges;
filling the one or more empty replacement toner printing cartridges with a mixture of a toner and a taggant, such that one or more security replacement toner printing cartridges are created;
wherein a security reader is able to detect the taggant;
installing the one or more security replacement toner printing cartridges into the at least one empty printing cartridge position;
the steps of providing the empty replacement toner printing cartridges may comprise: disassembling the one or more removed toner printing cartridges; and emptying and cleaning the one or more removed toner printing cartridges.

In one embodiment, all of the toner in one standard new toner and drum cartridge (for a 2 cartridge system) or one new “all in one” toner cartridge is removed and the toner is saved. This toner may then be mixed with a taggant and reloaded into the new, but now empty cartridge. This can also be done with a used cartridge. The same process of cleaning all the toner out is followed, but the toner from the used cartridge is generally not saved or reused. Instead, the but the Taggant is added to the new replacement toner. The final taggant-toner mixture is preferably 1-20% by weight of taggant and 80-99% by weight of toner. Preferably, the taggant is 5% wt/wt %. The taggant-toner mixture is mixed/shaken thoroughly and then put back into the empty new or used cartridge. If the toner cartridge has a separate drum, the drum is primed with a small amount of the mixture. The cartridge may then be reassembled and tested.

The Taggant may be a physical marker that is invisible in any color (even clear) and can be authenticated at any time with handheld detectors that are supplied by the manufacturer. The taggant detectors or readers are able to determine whether the specific taggant was used. Typically, in a color printer, only one of the color cartridges is made to use the security toner to further enhance the security. The things, such as labels, printed with the taggant toner can help protect brand integrity, stop counterfeiting, and product diversion.

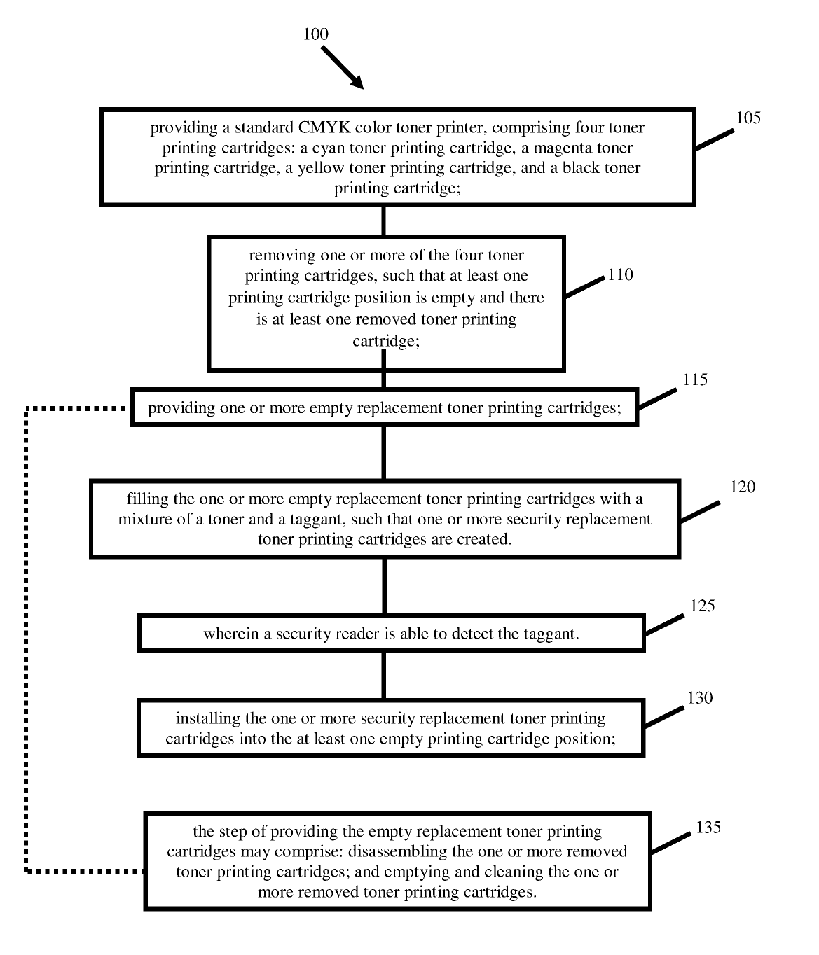

FIG. 1 is a flow block diagram of one embodiment of a method of converting a standard CMYK color toner printer to a CMYK security color taggant toner printer. As shown in FIG. 1, the method 100 may comprise the steps: 105 providing a standard CMYK color toner printer, comprising four toner printing cartridges: a cyan toner printing cartridge, a magenta toner printing cartridge, a yellow toner printing cartridge, and a black toner printing cartridge; 110 removing one or more of the four toner printing cartridges, such that at least one printing cartridge position is empty and there is at least one removed toner printing cartridge; 115 providing one or more empty replacement toner printing cartridges; 120 filling the one or more empty replacement toner printing cartridges with a mixture of a toner and a taggant, such that one or more security replacement toner printing cartridges are created; 125 wherein a security reader is able to detect the taggant; and 130 installing the one or more security replacement toner printing cartridges into the at least one empty printing cartridge position; wherein 135 the step of providing the empty replacement toner printing cartridges may comprise: disassembling the one or more removed toner printing cartridges; and emptying and cleaning the one or more said removed toner printing cartridges.

The toner printing cartridges may be cartridge and drum all in one cartridges or the drum unit may be separable. If they are separate, then the drum unit must also be emptied, cleaned, and primed. If the toner cartridges are new, the toner emptied from the cartridges may be used to mix with the taggant. If the removed cartridges are used, the toner removed is preferably not saved and reused or mixed with taggant.

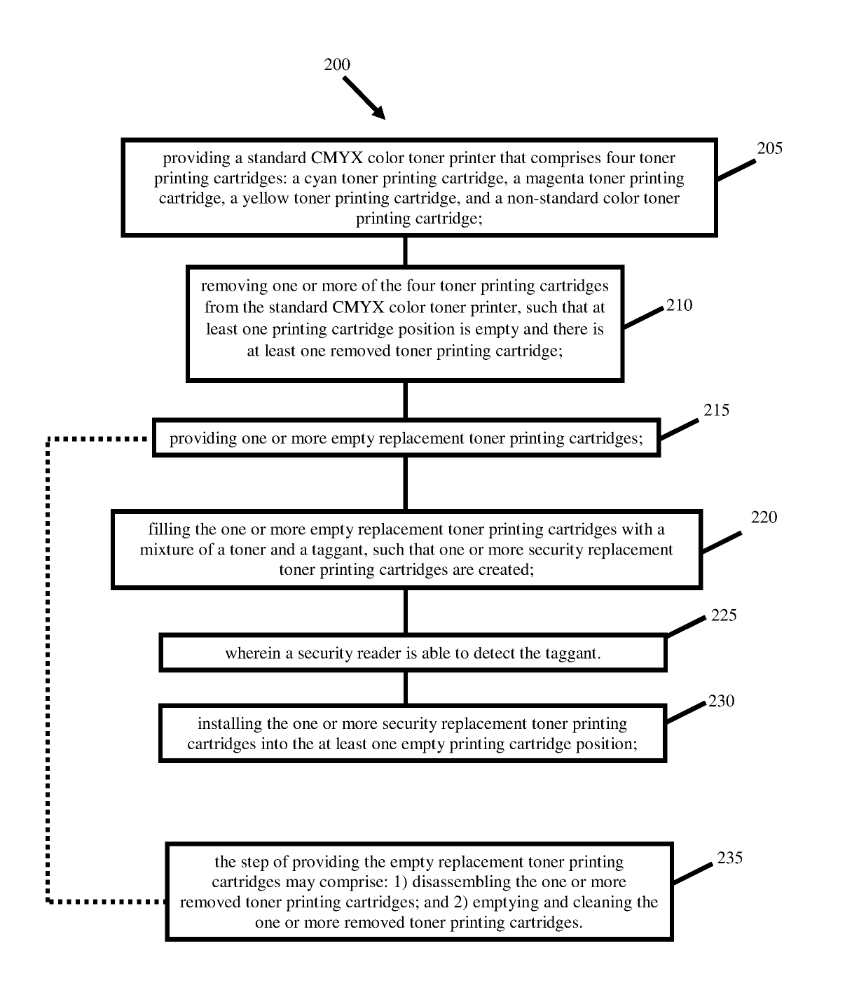

FIG. 2 is a flow block diagram of one embodiment of a method of converting a standard CMYK color toner printer to a CMYK security color taggant toner printer. As shown in FIG. 2, the method 200 may comprise the steps: 205 providing a standard CMYX color toner printer that comprises four toner printing cartridges: a cyan toner printing cartridge, a magenta toner printing cartridge, a yellow toner printing cartridge, and a non-standard color toner printing cartridge; 210 removing one or more of the four toner printing cartridges from the standard CMYX color toner printer, such that at least one printing cartridge position is empty and there is at least one removed toner printing cartridge; 215 providing one or more empty replacement toner printing cartridges; 220 filling the one or more empty replacement toner printing cartridges with a mixture of a toner and a taggant, such that one or more security replacement toner printing cartridges are created; 225 wherein a security reader is able to detect the taggant; 230 installing the one or more security replacement toner printing cartridges into the at least one empty printing cartridge position; wherein 235 the step of providing the empty replacement toner printing cartridges may comprise: 1) disassembling the one or more removed toner printing cartridges; and 2) emptying and cleaning the one or more removed toner printing cartridges.

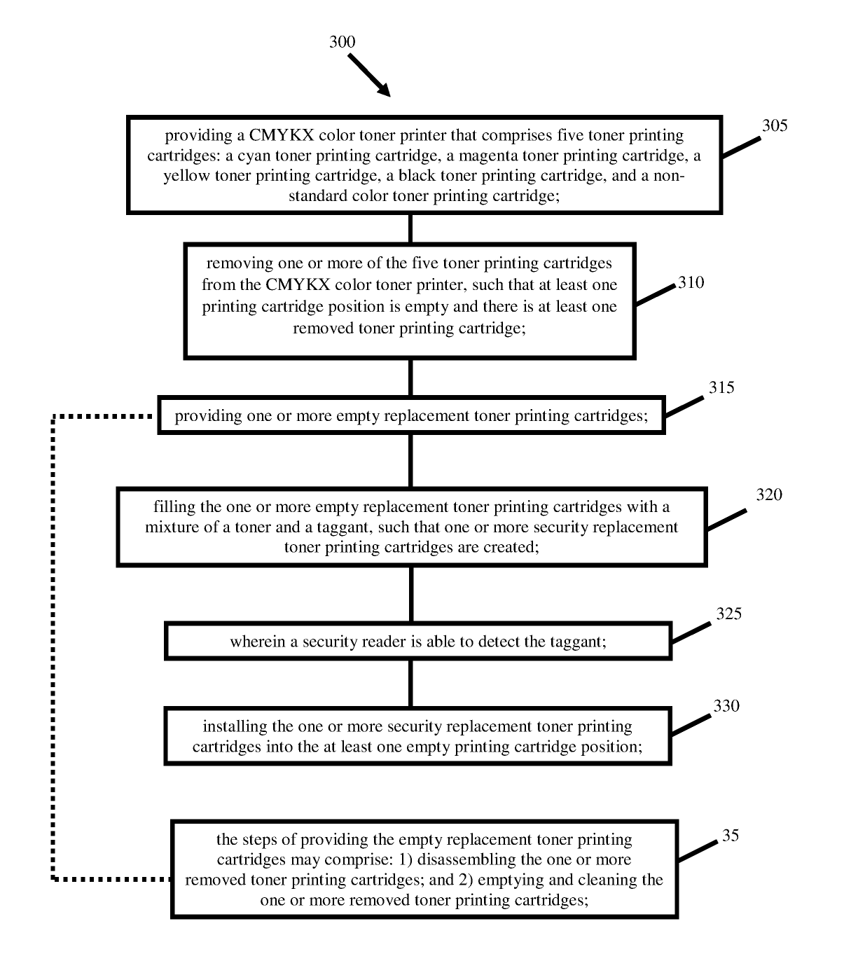

FIG. 3 is a flow block diagram of one embodiment of a method of converting a standard CMYKX color toner printer to a CMYKX security color taggant toner printer. As shown in FIG. 3, the method 300 may comprise the steps: 305 providing a standard CMYKX color toner printer that comprises five toner printing cartridges: a cyan toner printing cartridge, a magenta toner printing cartridge, a yellow toner printing cartridge, a black toner printing cartridge, and a non-standard color toner printing cartridge; 310 removing one or more of the five toner printing cartridges from the standard CMYKX color toner printer, such that at least one printing cartridge position is empty and there is at least one removed toner printing cartridge; 315 providing one or more empty replacement toner printing cartridges; 320 filling the one or more empty replacement toner printing cartridges with a mixture of a toner and a taggant, such that one or more security replacement toner printing cartridges are created; 325 wherein a security reader is able to detect the taggant; 330 installing the one or more security replacement toner printing cartridges into the at least one empty printing cartridge position; wherein 335 the steps of providing the empty replacement toner printing cartridges may comprise: 1) disassembling the one or more removed toner printing cartridges; and 2) emptying and cleaning the one or more removed toner printing cartridges.

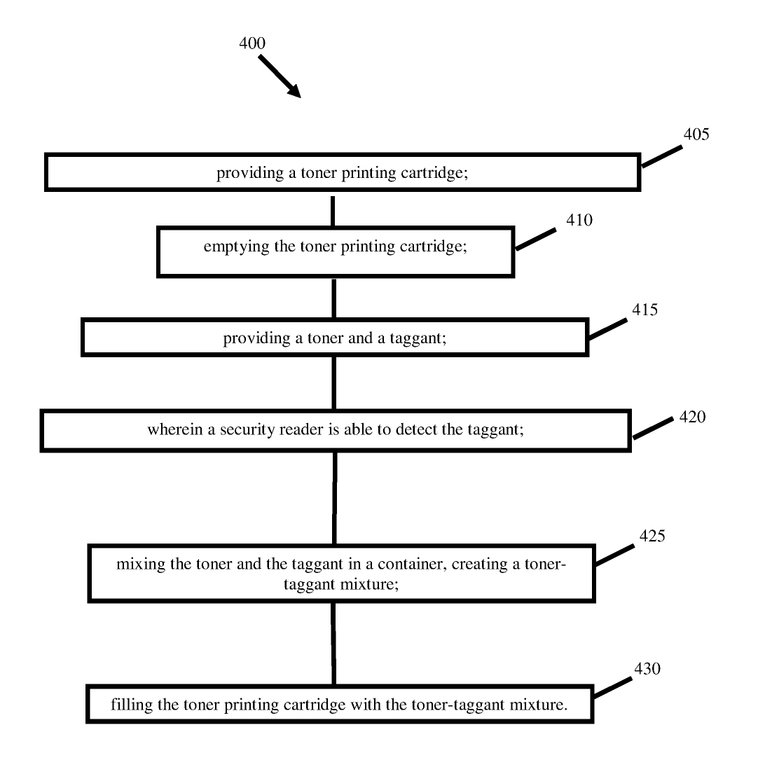

FIG. 4 is a flow block diagram of one embodiment of a method of converting a standard toner printing cartridge to a security toner printing cartridge. As shown in FIG. 4, the method 400 may comprise the steps: 405 providing a toner printing cartridge; 410 ensuring the toner printing cartridge is empty; 415 providing toner, taggant, and a container; 420 wherein a security reader is able to detect the taggant; 425 mixing the toner and the taggant in the container, creating a toner-taggant mixture; 430 filling the toner printing cartridge with the toner-taggant mixture. Preferably the taggant is 5-10% by weight volume of the toner-taggant mixture, but the taggant may be in the range of 1-20% by weight volume of the toner-taggant mixture.

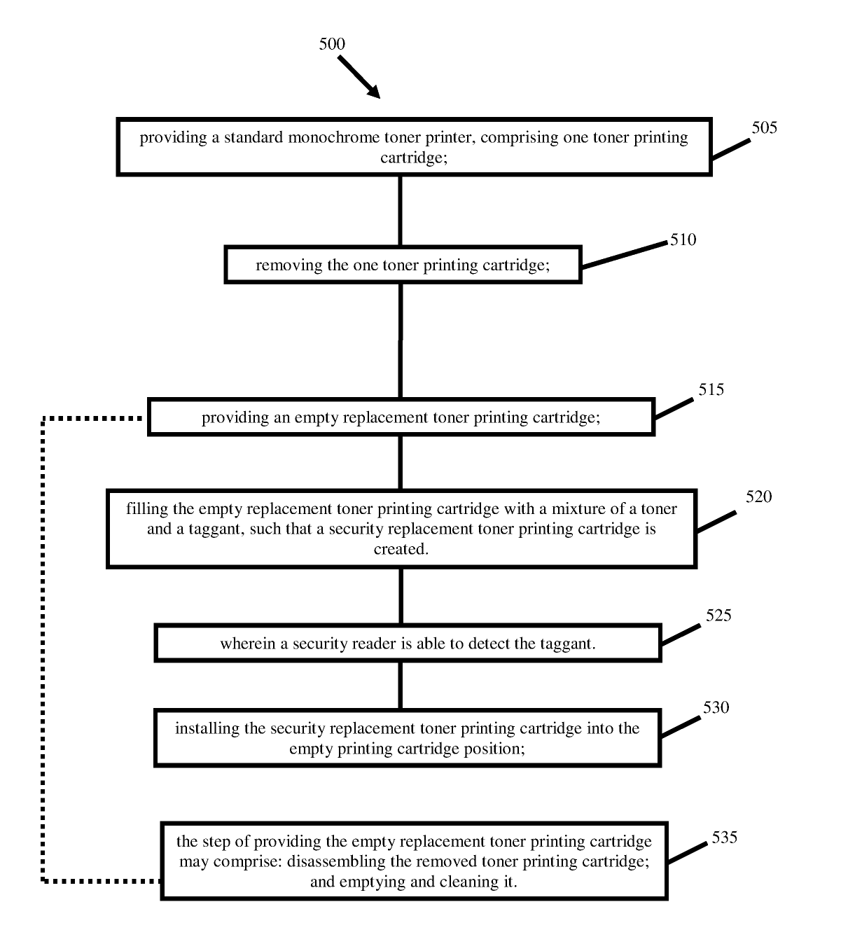

FIG. 5 is a flow block diagram of one embodiment of a method of converting a standard monochrome printer to a monochrome security taggant toner printer. As shown in FIG. 5, the method 500 may comprise the steps: 505 providing a standard monochrome toner printer, comprising one toner printing cartridge; 510 removing the toner printing cartridge, such that there may be a printing cartridge position that is empty and there a removed toner printing cartridge; 515 providing an empty replacement toner printing cartridge; 520 filling the empty replacement toner printing cartridge with a mixture of a toner and a taggant, such that a security replacement toner printing cartridge is created; 525 wherein a security reader is able to detect the taggant; 530 installing the security replacement toner printing cartridge into the empty printing cartridge position; 535 the step of providing the empty replacement toner printing cartridge may comprise: disassembling the removed toner printing cartridge; and emptying and cleaning it.

The toner printing cartridge may be a cartridge and drum all-in-one cartridge or the drum unit may be separable. If they are separate, then the drum unit must also be emptied, cleaned, and primed. If the toner cartridge is new, the toner emptied from the cartridges may be used to mix with the taggant. If the removed cartridge is used, the toner removed is preferably not saved and reused or mixed with taggant.

Unless otherwise stated, all measurements, values, ratings, positions, magnitudes, sizes, locations, and other specifications, which set forth in this specification, including in the claims that follow, are approximate, not exact. They are intended to have a reasonable range, which is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded as illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method of converting a standard CMYK color toner printer to a CMYK security color toner printer, comprising the steps:
providing a standard CMYK color toner printer that comprises four toner printing cartridges: a cyan toner printing cartridge, a magenta toner printing cartridge, a yellow toner printing cartridge, and a black toner printing cartridge;
removing one or more of said four toner printing cartridges from said standard CMYK color toner printer, such that at least one printing cartridge position is empty and there is at least one removed toner printing cartridge;
providing one or more empty replacement toner printing cartridges;
filling at least one of said one or more empty replacement toner printing cartridges with a mixture of a toner and a taggant, such that one or more security replacement toner printing cartridges are created;
wherein said taggant is configured to be detected by a security reader; and
installing said one or more security replacement toner printing cartridges into said at least one empty printing cartridge position.

2. The method of claim 1, wherein said one or more empty replacement toner printing cartridges are said one or more removed toner printing cartridges that have been emptied and cleaned.

3. The method of claim 1, wherein the step of providing said one or more of said empty replacement toner printing cartridges comprises: disassembling and cleaning said one or more removed toner printing cartridges.

4. The method of claim 1, wherein said one or more empty replacement toner printing cartridges are new.

5. The method of claim 1, wherein all of said four toner printing cartridges are removed and replaced with four security replacement toner printing cartridges.

6. The method of claim 1, wherein one or more colors of said one or more security replacement toner printing cartridges matches one or more colors of said at least one removed toner printing cartridge.

7. The method of claim 1, wherein said taggant in said mixture is approximately 1% to 20% weight by volume of said mixture.

8. The method of claim 7, wherein said taggant of said mixture is approximately 5% weight by volume of said mixture.

9. A method of converting a standard CMYX color toner printer to a CMYX security color toner printer, comprising the steps:
providing a standard CMYX color toner printer that comprises four toner printing cartridges: a cyan toner printing cartridge, a magenta toner printing cartridge, a yellow toner printing cartridge, and a non-standard toner printing cartridge;
removing one or more of said four toner printing cartridges from said standard CMYX color toner printer, such that at least one printing cartridge position is empty and there is at least one removed toner printing cartridge;
providing one or more empty replacement toner printing cartridges;
filling at least one of said one or more empty replacement toner printing cartridges with a mixture of a toner and a taggant, such that one or more security replacement toner printing cartridges are created;
wherein said taggant is configured to be detected by a security reader; and
installing said one or more security replacement toner printing cartridges into said at least one empty printing cartridge position.

10. The method of claim 9, wherein said one or more empty replacement toner printing cartridges are said one or more removed toner printing cartridges that have been emptied and cleaned.

11. The method of claim 9, wherein the step of providing said one or more of said empty replacement toner printing cartridges comprises: disassembling and cleaning said one or more removed toner printing cartridges.

12. The method of claim 9, wherein said one or more empty replacement toner printing cartridges are new.

13. The method of claim 9, wherein all of said four toner printing cartridges are removed and replaced with four security replacement toner printing cartridges.

14. The method of claim 9, wherein one or more colors of said one or more security replacement toner printing cartridges matches one or more colors of said at least one removed toner printing cartridge.

15. The method of claim 9, wherein said taggant in said mixture is approximately 1% to 20% weight by volume of said mixture.

16. The method of claim 15, wherein said taggant of said mixture is approximately 5% weight by volume of said mixture.

17. The method of claim 9, wherein said non-standard color toner is selected from the group of toners consisting of at least one of: white, metallic, fluorescent, light, clear, clear fluorescent, sublimation, ceramic, and combinations thereof.

18. A method of converting a CMYKX color toner printer to a CMYKX security color toner printer, comprising the steps:
providing a standard CMYKX color toner printer that comprises five toner printing cartridges: a cyan toner printing cartridge, a magenta toner printing cartridge, a yellow toner printing cartridge, a black toner printing cartridge, and a non-standard toner printing cartridge;
removing one or more of said five toner printing cartridges from said CMYKX color toner printer, such that at least one printing cartridge position is empty and there is at least one removed toner printing cartridge;
providing one or more empty replacement toner printing cartridges;
filling at least one of said one or more empty replacement toner printing cartridges with a mixture of a toner and a taggant, such that one or more security replacement toner printing cartridges are created;
wherein said taggant is configured to be detected by a security reader; and
installing said one or more security replacement toner printing cartridges into said at least one empty printing cartridge position.

19. The method of claim 18, wherein said one or more empty replacement toner printing cartridges are said one or more removed toner printing cartridges that have been emptied and cleaned.

20. The method of claim 18, wherein the step of providing said one or more of said empty replacement toner printing cartridges comprises: disassembling and cleaning said one or more removed toner printing cartridges.

21. The method of claim 18, wherein said one or more empty replacement toner printing cartridges are new.

22. The method of claim 18, wherein all of said five toner printing cartridges are removed and replaced with five security replacement toner printing cartridges.

23. The method of claim 18, wherein one or more colors of said one or more security replacement toner printing cartridges matches one or more colors of said at least one removed toner printing cartridge.

24. The method of claim 18, wherein said taggant in said mixture is approximately 1% to 20% weight by volume of said mixture.

25. The method of claim 24, wherein said taggant of said mixture is approximately 5% weight by volume of said mixture.

26. The method of claim 18, wherein said non-standard color toner is selected from the group of toners consisting of at least one of: white, metallic, fluorescent, light, clear, clear fluorescent, sublimation, ceramic, and combinations thereof.

27. A method of converting a standard toner printing cartridge to a security toner printing cartridge, comprising the steps:
providing a toner printing cartridge;
emptying said toner printing cartridge;
providing a toner and a taggant;
wherein a security reader is able to detect said taggant;
mixing said toner and said taggant in a container, creating a toner-taggant mixture; and
filling said toner printing cartridge with said toner-taggant mixture.

28. The method of claim 27, wherein said toner printing cartridge is a new toner printing cartridge and wherein a toner removed from said new toner printing cartridge is said toner that is mixed with said taggant.

29. The method of claim 27, wherein said toner printing cartridge is a used toner printing cartridge and wherein a toner removed from said used toner printing cartridge is not reused.

30. The method of claim 27, wherein the step of emptying said toner printing cartridge comprises the steps of: disassembling and cleaning said toner printing cartridge.

31. The method of claim 27, wherein said taggant in said toner-taggant mixture is approximately 1% to 20% weight by volume of said toner-taggant mixture.

32. The method of claim 31, wherein said taggant of said toner-taggant mixture is approximately 5% weight by volume of said toner-taggant mixture.

33. A method of converting a standard monochrome toner printer to a monochrome security toner printer, comprising the steps:
providing a standard monochrome toner printer that comprises a toner printing cartridge;
removing said toner printing cartridge from said standard monochrome toner printer, such that a printing cartridge position is empty and there is a removed toner printing cartridge;
providing an empty replacement toner printing cartridge;
filling said empty replacement toner printing cartridge with a mixture of a toner and a taggant, such that a security replacement toner printing cartridge is created;
wherein said taggant is configured to be detected by a security reader; and
installing said security replacement toner printing cartridge into said empty printing cartridge position.

34. The method of claim 33, wherein said empty replacement toner printing cartridge is said removed toner printing cartridge that has been emptied and cleaned.

35. The method of claim 33, wherein the step of providing said empty replacement toner printing cartridge comprises: disassembling and cleaning said removed toner printing cartridge.

36. The method of claim 33, wherein said empty replacement toner printing cartridge is new.

37. The method of claim 33, wherein said taggant in said mixture is approximately 1% to 20% weight by volume of said mixture.

38. The method of claim 37, wherein said taggant of said mixture is approximately 5% weight by volume of said mixture.
